(19) United States
(12) Patent Application Publication
(10) Pub. No.: US 2016/0279575 A1
(43) Pub. Date: Sep. 29, 2016

(54) FLOW PATH MEMBER AND FORWARD OSMOSIS MEMBRANE ELEMENT

(71) Applicant: NITTO DENKO CORPORATION, Ibaraki-shi, Osaka (JP)

(72) Inventors: Makoto KOBUKE, Osaka (JP); Yasuhiro UDA, Osaka (JP)

(21) Appl. No.: 15/032,989

(22) PCT Filed: Jul. 1, 2014
(86) PCT No.: PCT/JP2014/003514

§ 371 Date: Apr. 28, 2016

(30) Foreign Application Priority Data
Oct. 29, 2013 (JP) 2013-224106

(51) Int. Cl. B01D 63/10; C02F 1/44; B01D 61/00

(52) U.S. Cl. CPC B01D 63/103; B01D 61/002; C02F 1/445; B01D 2313/14; B01D 2313/08; C02F 2103/08

(57) ABSTRACT

A flow path member (10) includes: a first net (11) having first filaments (11A) and second filaments (11B) that are joined together so that the first filaments (11A) extend in a first direction and form one surface of the first net (11) and the second filaments (11B) extend in a second direction that intersects the first direction and form the other surface of the first net (11); and second nets (12) each having smoother surfaces than the surfaces of the first net (11). The second nets (12) are disposed on both sides of the first net (11). Thus, damage to a separation membrane is reduced and pressure drop is reduced.

### TECHNICAL FIELD

The present invention relates to a flow path member and a forward osmosis membrane element including the flow path member disposed therein.

### BACKGROUND ART

Separation membrane systems using reverse or forward osmosis have recently been developed for wastewater treatment, seawater desalination, osmotic power generation, etc. For example, Patent Literature 1 proposes a less environmentally damaging system for achieving both seawater desalination using a reverse osmosis module and dilution of highly concentrated seawater using a forward osmosis module including a forward osmosis membrane to produce medium concentration seawater to be discharged to the sea.

Patent Literature 2 discloses a spiral-wound forward osmosis membrane module including a central tube and envelope-like membrane leaves collectively wound around the central tube. Each of the membrane leaves is formed by sealing, with an epoxy resin or the like, the peripheral edges of a stack of two forward osmosis membranes and a porous flow path member interposed therebetween. A serpentine flow path is formed in each membrane leaf so that a fluid fed into the central tube once leaves the tube and again returns to the tube on its downstream side. A porous flow path member is disposed in the flow path inside the membrane leaf. Patent Literature 2 describes the use of a flow path member made of a tricot knitted fabric, for example, as the porous flow path member.

A flow path member made of a tricot knitted fabric is also used as a permeate water-side flow path member of a reverse osmosis membrane module, as described in Patent Literature 3, and grooves between ribs of the fabric serve as flow paths for permeate water.

### CITATION LIST

### Patent Literature

Patent Literature 1: JP 2005-279540 A

Patent Literature 2: U.S. Pat. No. 4,033,878 A

Patent Literature 3: JP 2000-354743 A

### SUMMARY OF INVENTION

### Technical Problem

In a flow path member made of a tricot knitted fabric as described in Patent Literature 2 or Patent Literature 3, a yarn is knitted into a pattern that allows a fluid to flow smoothly in one direction. Therefore, when the fluid flows only in that direction in the flow path member, only a small pressure drop occurs in the fluid flow. However, when the fluid needs to flow both in that direction and in the opposite direction, a larger pressure drop may occur in the fluid flow in the flow path member. In addition, a separation membrane may be damaged when it comes into contact with the ribs of the flow path member.

Under these circumstances, it is an object of the present invention to provide a flow path member that produces only small pressure drops in both the fluid flow in one direction and the fluid flow in the opposite direction and that is less damaging to a separation membrane.

### Solution to Problem

The present invention provides a flow path member including: a first net having first filaments and second filaments that are joined together so that the first filaments extend in a first direction and form one surface of the first net and the second filaments extend in a second direction that intersects the first direction and form the other surface of the first net; and second nets each having smoother surfaces than the surfaces of the first net. In this flow path member, the second nets are disposed on both sides of the first net.

The present invention further provides a forward osmosis membrane element including: the flow path member; and forward osmosis membranes disposed on both sides of the flow path member.

### Advantageous Effects of Invention

According to the flow path member configured as described above, in the flow path formed between the first filaments or between the second filaments, the pressure drop in the flow of the fluid in one direction is almost equal to the pressure drop in the flow of the fluid in the opposite direction. Therefore, the flow path member of the present invention achieves small pressure drops in both the fluid flow in one direction and the fluid flow in the opposite direction. In addition, the second nets each having smoother surfaces than the surfaces of the first net are disposed on both sides of the first net. Since a separation membrane comes into contact with these second nets, it is less likely to be damaged.

### BRIEF DESCRIPTION OF DRAWINGS

FIG. 1A is a cross-sectional view of a flow path member of the present embodiment.

FIG. 1B is a cross-sectional view of a stack of the flow path member of the present embodiment and forward osmosis membranes disposed on the flow path member.

FIG. 2A is a plan view of a first net of the present embodiment.

FIG. 2B is a cross-sectional view of the first net, taken along the line A1-A1 in FIG. 2A.

FIG. 2C is a cross-sectional view of the first net, taken along the line B1-B1 in FIG. 2C.

FIG. 3 is an enlarged view of a part of the cross-sectional view of FIG. 2C.

FIG. 4A is a plan view of a second net of the present embodiment.

FIG. 4B is a cross-sectional view of the second net, taken along the line A2-A2 in FIG. 4A.

FIG. 4C is a cross-sectional view of the second net, taken along the line B2-B2 in FIG. 4A.

FIG. 5A is a plan view of a second net of a modification.

FIG. 5B is a cross-sectional view of the second net, taken along the line A3-A3 in FIG. 5A.

FIG. 5C is a cross-sectional view of the second net, taken along the line B3-B3 in FIG. 5A.

FIG. 6 is a schematic cross-sectional view of a forward osmosis membrane module of the present embodiment.

FIG. 7A is a perspective view of a layered body before being wound around a central tube.

FIG. 7B is a schematic cross-sectional view of a forward osmosis membrane element including the layered body that is wound around the central tube.

FIG. 8 is a schematic view showing the flow of a fluid in a central tube and in a membrane leaf.

### DESCRIPTION OF EMBODIMENTS

Hereinafter, embodiments of the present invention are described with reference to the drawings. The following description is merely exemplary in nature and is not intended to limit the present invention to the following embodiments.

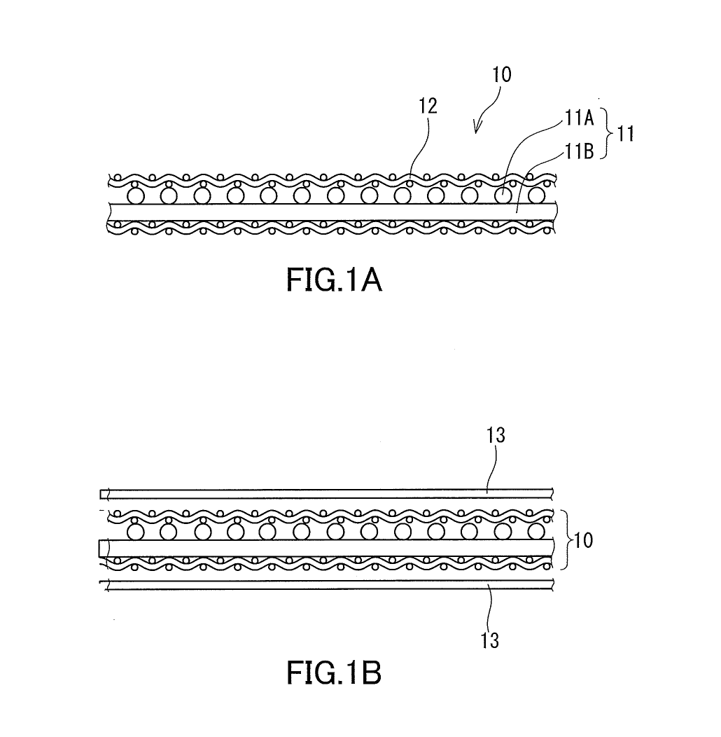

FIG. 1A shows a flow path member 10 of the present embodiment. The flow path member 10 includes a first net 11 and second nets 12. The second nets 12 are disposed on both sides of the first net 11. This flow path member is typically used in a forward osmosis membrane element 2 to be described later. For example, the flow path member is disposed between forward osmosis membranes 13, as shown in FIG. 1B, to form a flow path through which a fluid can flow.

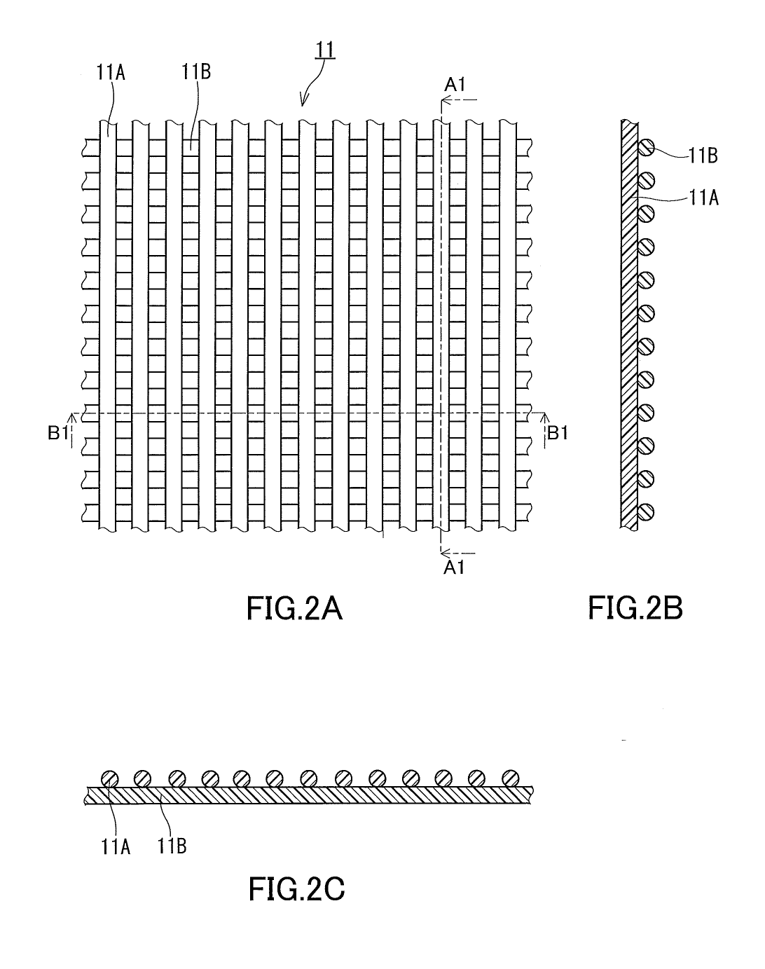

The first net 11 includes first filaments 11A and second filaments 11B that are joined together. As shown in FIG. 2A, the first filaments 11A extend in a first direction and form one surface of the first net 11. The second filaments 11B extend in a second direction that intersects the first direction and form the other surface of the first net 11. In FIG. 2A, the first filaments 11A and the second filaments 11B are perpendicular to each other, but they do not always have to be perpendicular to each other. For example, the first filaments 11A and the second filaments 11B may intersect each other so that the first filaments 11A and the second filaments 11B form an acute angle of 30 to 80 degrees therebetween.

The first filaments 11A and the second filaments 11B are made of a resin, such as nylon, polyester, polyethylene, or polypropylene. That is, the first net 11 is a resin net. The first filament 11A and the second filament 11B may be joined by fusion or may be joined with an adhesive or the like. It is desirable to join them by fusion in order to ensure the strength of the first net 11. Specifically, for example, the first net 11 can be obtained as follows. The first filaments 22A and the second filaments 22B are extruded from nozzle holes formed in a circular pattern in two oppositely rotating inner and outer dies of an extruder. The first filaments 11A and the second filaments 11B thus extruded are fused together at their intersections, immersed in a cooling bath, and then removed therefrom.

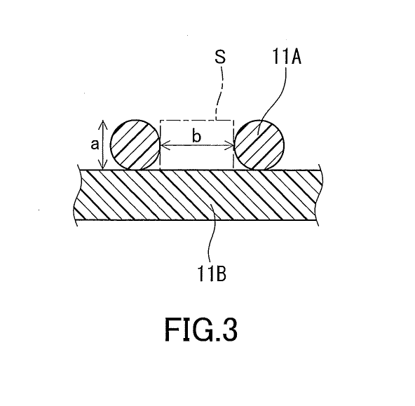

A reference plane including the interface between the first filaments 11A and the second filament 11B is determined. As shown in FIG. 3, the first filaments 11A project to a height of “a” from the reference plane in one thickness direction of the first net 11, and the second filaments 11B also project to a height of “a” from the reference plane in the other thickness direction of the first net 11 opposite to the projecting direction of the first filaments 11A. Thus, a flow path for the fluid is formed between the adjacent first filaments 11A in one surface of the first net 11, while a flow path for the fluid is formed between the adjacent second filaments 11B in the other surface of the first net 11.

The distance between the adjacent first filaments 11A (the shortest distance between the first filaments 11A) is defined as “b”. The shape of the cross section of the flow path formed between the adjacent first filaments 11A is approximate to a rectangle S with a height “a” and a width “b” as shown in FIG. 3. The hydraulic diameter Dh of the flow path having this cross section S is defined by the following equation:

Dh=4ab/(2a+2b)

The hydraulic diameter Dh mentioned above is related to the pressure drop in the flow of the fluid in the flow path member 11. In the present embodiment, it is desirable that the first net 11 be configured to form a flow path having a hydraulic diameter Dh of 2 mm or more in order to reduce the pressure drop. The thickness of the first net 11 is desirably 100 μm or more, and more desirably 300 μm or more to obtain a hydraulic diameter Dh of 2 mm or more. Likewise, the diameter of the first filaments 11A or the second filaments 11B is desirably 50 μm or more, and more desirably 150 μm or more. If the diameter of the first filaments 11A or the second filaments 11B is too small, the first filaments 11A or the second filaments 11B are more likely to dig into a separation membrane such as a forward osmosis membrane. In order to prevent the first filaments 11A or the second filaments 11B from digging into the separation membrane, it is desirable that the diameter of the first filaments 11A or the second filaments 11B fall within the above-mentioned range. If the first net 11 is too thick, the volume of a separation membrane such as a forward osmosis membrane that can be loaded in an element such as a forward osmosis membrane element is reduced. In view of this, the thickness of the first net 11 is desirably 1000 μm or less. Likewise, the diameter of the first filaments or the second filaments is desirably 500 μm or less. The thickness of the flow path member 10 is desirably 500 μm to 1000 μm.

The fluid flows in the flow path between the first filaments 11A or between the second filaments 11B. In the flow path formed between the first filaments 11A, the pressure drop in the flow of the fluid in one direction is almost equal to the pressure drop in the flow of the fluid in the opposite direction. The same applies in the flow path formed between the second filaments 11B. Therefore, even when there are fluid flows both in one direction and in the opposite direction in the flow path member 10, an increase in the pressure drop in the fluid flow in one of these directions is prevented. Thus, the pressure drop in the flow of the fluid in the flow path member 10 is reduced.

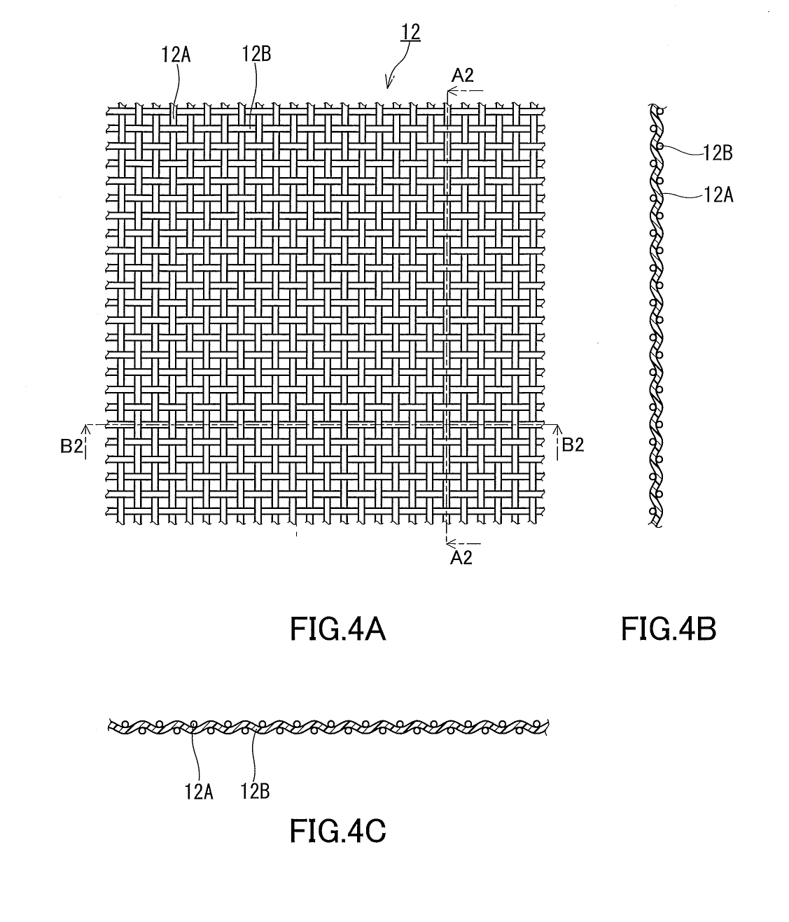

For example, the second net 12 is a woven fabric having an array of filaments 12A and 12B extending longitudinally and transversely, as shown in FIG. 4A to FIG. 4C. FIG. 4A to FIG. 4C each shows a plain weave fabric, but the second net 12 may be a twill weave fabric or a satin weave fabric. The use of a woven fabric as the second net 12 allows the second net 12 to have high strength. The filaments 12A and 12B are made of a resin, such as nylon, polyester, polyethylene, or polypropylene. The surfaces of the second net 12 are smoother than the surfaces of the first net 11. In other words, when the through-thickness cross section of the first net 11 is compared with the through-thickness cross section of the second net 12, ribs on the second net 12 are smaller than those on the first net 11. As described above, when this flow path member 10 is used together with a separation membrane such as the forward osmosis membrane 13, the separation membrane comes into contact not with the first filaments 11A or the second filaments 11B but with one surface of the second net 12. Thus, damage of the separation membrane can be reduced when it comes into contact with the flow path member.

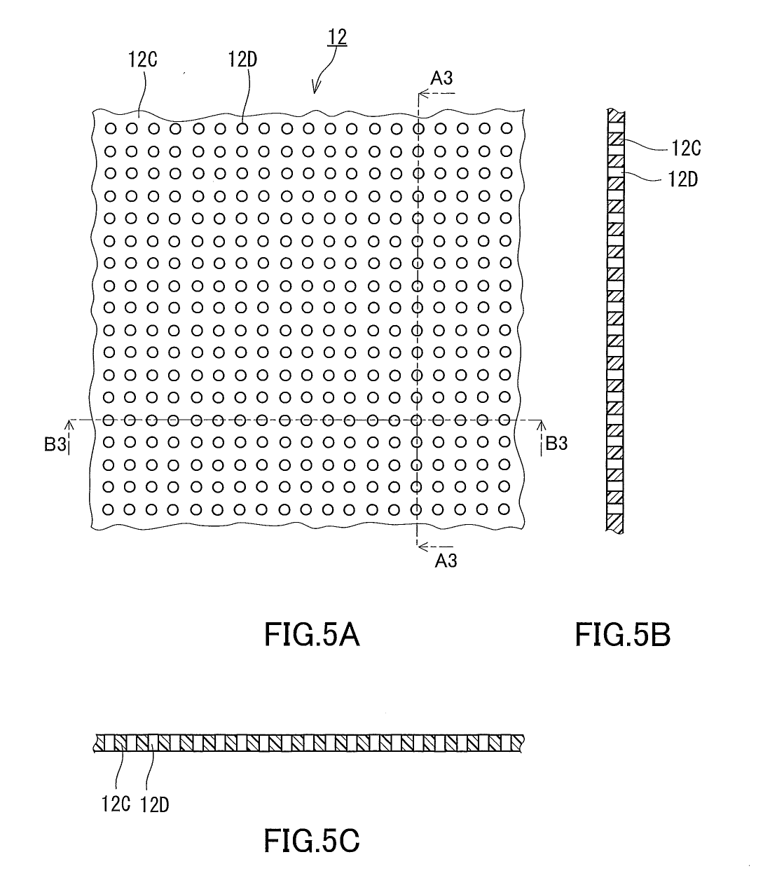

For example, the second net 12 may be a net obtained by forming through holes 12D in a sheet 12C having smooth surfaces, as shown in FIG. 5A to FIG. 5C. The second net 12 having this configuration can reduce damage to the separation membrane more dramatically even when the membrane comes into contact with the flow path member. The sheet 12C is made of a resin, such as nylon, polyester, polyethylene, or polypropylene.

If the mesh count of the second net 12 is too low, the open area ratio of the second net 12 is too high, which may cause the separation membrane to be depressed into the openings of the second net 12. In view of this, the mesh count of the second net 12 is, for example, 50 or more, more preferably 70 or more, and even more preferably 85 mesh or more. On the other hand, if the mesh count of the second net 12 is too high, the diameter of the filaments 12A and 12B of the second net 12 are too small, which results in insufficient strength of the second net 12. In view of this, the mesh count of the second net 12 is, for example, 300 or less, more preferably 150 or less, and even more preferably 110 or less. As used in this description, the term “mesh count” refers to the number of openings per inch (25.4 mm), which indicates the mesh density.

On the other hand, it is desirable that the mesh count of the first net 11 be lower than that of the second net 12. In order to reduce the pressure drop, the mesh count of the first net 11 is, for example, 5 to 80, and more desirably 10 to 50.

Another net may further be disposed between the first net 11 and the second net 12. Alternatively, an adhesive or a tackifier may be interposed between the first net 11 and the second net 12.

Next, a forward osmosis membrane element using this flow path member 10 and a forward osmosis membrane module using this forward osmosis membrane element are described.

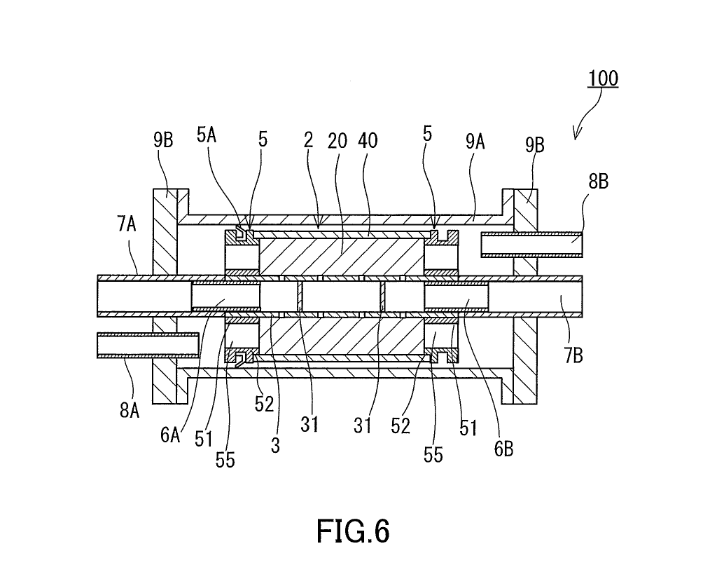

As shown in FIG. 6, a forward osmosis membrane module 100 includes a tubular pressure container 9A called a vessel and a forward osmosis membrane element 2 loaded in the pressure container 9A. Disc-shaped caps 9B are attached to both ends of the pressure container 9A. A central feed tube 7A is secured to the center of one of the caps 9B (on the left side in FIG. 6). A peripheral feed tube 8A is also secured to that cap 9B at a position spaced from the center of the cap 9B. A central discharge tube 7B is secured to the center of the other cap 9B (on the right side in FIG. 6). A peripheral discharge tube 8B is also secured to that cap 9B at a position spaced from the center of the cap 9B.

One end of the forward osmosis membrane element 2 loaded in the pressure container 9A is connected to the central feed tube 7A by a connecting plug 6A. The other end of the forward osmosis membrane element 2 is connected to the central discharge tube 7B by a connecting plug 6B.

A first fluid to be concentrated and a second fluid to be diluted are fed to the forward osmosis membrane module 100. The second fluid has a higher osmotic pressure than the first fluid. The first fluid flows through the pressure container 9A from the central feed tube 7A toward the central discharge tube 7B while passing through the interior of the forward osmosis membrane element 2. The first fluid is concentrated by passing through the interior of the forward osmosis membrane element 2. On the other hand, the second fluid is fed into the pressure container 9A through the peripheral feed tube 8A. The second fluid thus fed into the pressure container 9A flows toward the peripheral discharge tube 8B while passing through the forward osmosis membrane element 2 and is discharged from the peripheral discharge tube 8B. The second fluid is diluted by passing through the forward osmosis membrane element 2.

The first fluid and the second fluid flow in parallel along the surfaces of a later-described forward osmosis membrane 13 in the forward osmosis membrane element 2. Since the osmotic pressure of the second fluid is higher than that of the first fluid, a portion of the first fluid moves toward the second fluid through the forward osmosis membrane 13 by osmotic phenomenon. As a result, the flow rate of the fluid discharged from the peripheral discharge tube 8B is higher than the flow rate of the fluid fed to the peripheral feed tube 8A.

For example, freshwater is used as the first fluid, and seawater is used as the second fluid. However, the first fluid and the second fluid are not limited to freshwater and seawater. Raw seawater may be used as the first fluid, and concentrated seawater having a higher salt concentration than the raw seawater may be used as the second fluid. This means that the osmotic pressure of the first fluid and that of the second fluid need to be different from each other. The first fluid to be concentrated is not limited to a solute-containing fluid that can be actually concentrated. The first fluid may be a substantially solute-free fluid like freshwater.

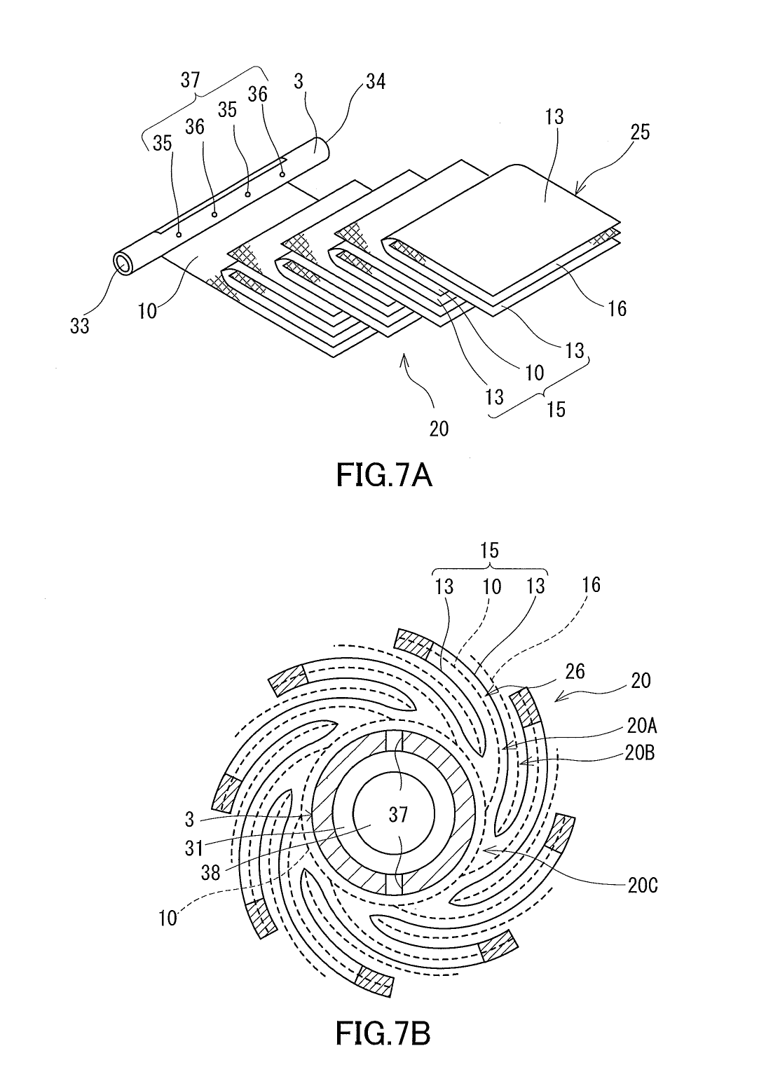

Next, the configuration of the forward osmosis membrane element 2 is described in detail with reference to FIG. 6 and FIG. 7.

The forward osmosis membrane elements 2 has a central tube 3, a layered body 20 wound around the central tube 3, and a sheath member 40 covering the layered body 20. End members 5 are attached to both ends of the central tube 3 so as to interpose the layered body 20 therebetween. The sheath member 40 is held by the end members 5 on both sides thereof. The end members 5 serve to prevent the layered body 20 wound around the central tube 3 from extending telescopically. A sealing member 5A having a V- or U-shaped cross section is fitted in a groove formed in the outer periphery of one of the end members 5 so as to seal the space between the end member 5 and the inner peripheral surface of the pressure container 9A.

As shown in FIG. 7A, the central tube 3 has a feed port 33 at one end and a discharge port 34 at the other end. Communication holes 37 arranged in the axial direction of the central tube 3 are formed therein. Specifically, as shown in FIG. 7B, two rows of communication holes 37 arranged in the axial direction of the central tube 3 are formed so that these rows are located farthest from each other in the circumferential direction of the wall of the central tube 3.

The layered body 20 has a configuration in which outer flow path members 16 and envelope-like membrane leaves 15 are alternately stacked. Each of the membrane leaves includes the above-described flow path member 10 and forward osmosis membranes 13 placed on both sides of the flow path member 10. As shown in FIG. 7B, the membrane leaves 15 are wound around the central tube 3. That is, the forward osmosis membrane element 2 is a spiral-wound element. The flow path member 10 forms a first fluid flow path 20A between the forward osmosis membranes 13 so as to allow the first fluid to flow therethrough. The outer flow path member 16, which is, for example a resin net, forms a second fluid flow path 20B between the membrane leaves 15 so as to allow the second fluid to flow therethrough.

For example, a single continuous sheet 25 is folded into two layers with the outer flow path member 16 interposed therebetween so as to form two forward osmosis membranes 13. The forward osmosis membranes 13 thus formed are joined together along the three edges thereof with the flow path member 10 interposed therebetween. Thus, the membrane leaf 15 is obtained. An adhesive is used for this joining. For example, one of the flow path members 10 has an extension portion, the extension portion is directly wound around the central tube 3, and both ends of the extension portion are sealed with an adhesive. Thus, a tubular flow path 20C is formed around the outer peripheral surface of the central tube 21. The tubular flow path 20C need not necessarily be formed.

As the forward osmosis membrane 13, for example, a composite membrane composed of a porous support and a skin layer formed thereon can be used. The porous support is, for example, a porous epoxy resin membrane or a porous polysulfone membrane. It is desirable to use a porous epoxy resin membrane as the porous support because it is a symmetric membrane having pores with a substantially constant diameter in the thickness direction of the membrane and has high self-standability. In order to increase the flow rate of the fluid passing through the forward osmosis membrane 13, it is desirable that the porous support have a smaller thickness, a higher porosity, and a tortuosity close to 1.

As the skin layer formed on the porous support, a skin layer containing a polyamide resin obtained by polymerizing a polyfunctional amine component and a polyfunctional acid halide component can be used. A polyfunctional amine component is a polyfunctional amine having two or more reactive amino groups, and examples of such a polyfunctional amine include aromatic, aliphatic, and alicyclic polyfunctional amines. A polyfunctional acid halide component is a polyfunctional acid halide having two or more reactive carbonyl groups. Examples of such a polyfunctional acid halide include aromatic, aliphatic, and alicyclic polyfunctional acid halides.

The method for forming a skin layer containing a polyamide resin on the surface of a porous epoxy resin membrane is not particularly limited, and any known method can be used. For example, interfacial condensation, phase separation, or thin film coating can be used. For example, it is possible to form a skin layer by bringing an aqueous amine solution containing a polyfunctional amine component into contact with an organic solution containing a polyfunctional acid halide component and then place the skin layer on a porous epoxy resin membrane. The thickness of the skin layer formed on the porous epoxy resin membrane is not particularly limited, and the thickness is usually about 0.05 to 2 μm, and preferably 0.1 to 1 μm.

The thickness of the forward osmosis membrane 13 is not particularly limited. In terms of the strength, water permeability for practical use, and salt impermeability, the forward osmosis membrane 13 may be subjected to surface treatment or a reinforcing layer may be formed thereon. The thickness of the forward osmosis membrane 13 is, for example, 10 to 250 μm, and preferably 10 to 150 μm.

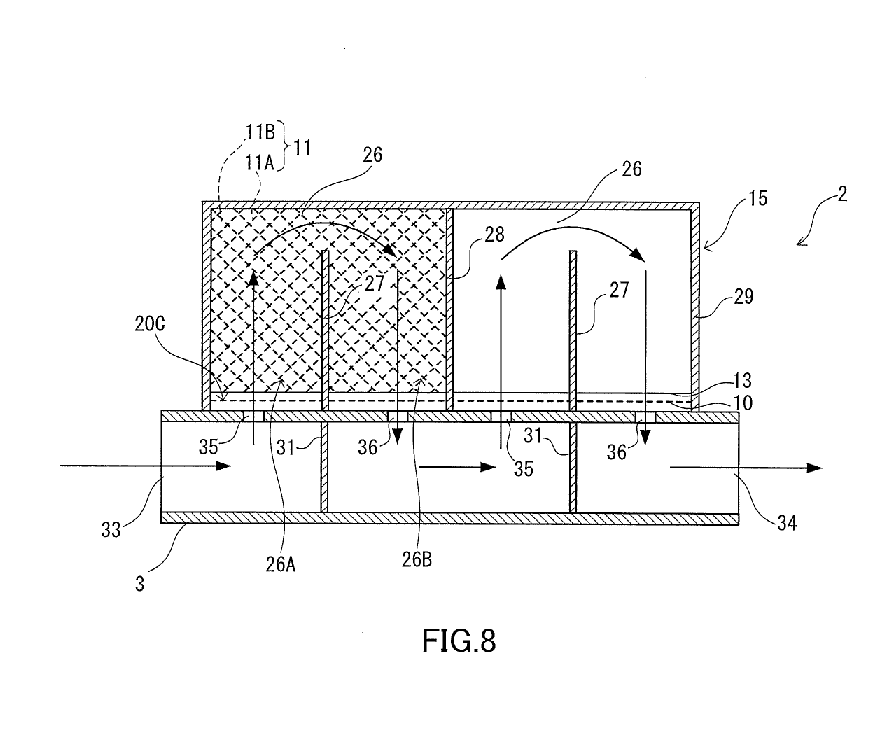

The interior of the central tube 3 and the interior of the membrane leaf 15 are described in detail with reference to FIG. 8. FIG. 8 is a diagram showing schematically the flow of the first fluid in the central tube 3 and in the membrane leaf 15. For the sake of simplicity, FIG. 8 shows only the first net 11 of the flow path member 10 in only one selected membrane leaf 15. As shown in FIG. 8, the first fluid flows from the feed port 33 toward the discharge port 34 through the central tube 3 and the membrane leaf 15.

In the membrane leaf 15, two forward osmosis membranes 13 are joined together along the three edges thereof by a joining portion 29 made of the adhesive mentioned above, and thereby a space is defined between the membranes 13. This space is partitioned by a joining portion 28 made of an adhesive, for example, and extending from approximately the center of the edge of the membrane leaf 15 on which the joining portion 29 is not formed to the opposite edge thereof so as to join the two forward osmosis membranes 13 along the joining portion 28. Thus, two internal flow paths 26 are formed side by side in the axial direction of the central tube 3 with the joining portion 28 interposed therebetween. Each of the internal flow paths 26 is partitioned into an upstream side space (left side in FIG. 8) and a downstream side space (right side in FIG. 8) by a joining portion 27 made of an adhesive, for example, for joining the two forward osmosis membranes 13. These joining portions 27, 28, and 29 form each of the internal flow paths 26 as a U-shaped curved flow path extending from an inlet opening 26A to an outlet opening 26B. In each membrane leaf 15, two internal flow paths 26 are formed side by side, and the inlet openings 26A and the outlet openings 26B of these internal flow paths 26 are alternately arranged in the axial direction of the central tube 3.

The flow path member 10 is disposed between the two forward osmosis membranes 13. In other words, the flow path member 10 is disposed in the internal flow path 26. The flow path member 10 is disposed in such a manner that the first filaments 11A and the second filaments 11B extend obliquely to the edge of the forward osmosis membrane 13.

The joining portions 27, 28, and 29 extend to the outer peripheral surface of the central tube 3 and partitions the tubular flow path 20C. Thus, the inlet opening 26A and the outlet opening 26B are separated from each other. Even if the tubular flow path 20C is not formed, the inlet opening 26A and the outlet opening 26B are separated from each other by the joining portions 27, 28, and 29 extending to the outer peripheral surface of the central tube.

The above-described plurality of communication holes 37 aligned in the axial direction of the central tube 3 include feed holes 35 and collection holes 36. The feed holes 35 each communicate with the internal flow path 26 through the inlet opening 26A and the tubular flow path 20C, while the collection holes 36 each communicate with the internal flow path 26 through the outlet opening 26B and the tubular flow path 20C. Thus, the internal flow path 26 communicates with the interior of the central tube 3 through the inlet opening 26A and the outlet opening 26B. In a real configuration, each inlet opening 26A communicates with a plurality of feed holes 35, and each outlet opening 26B communicates with a plurality of collection holes 36. For the sake of simplicity, however, FIG. 8 shows only one feed hole or collection hole communicating with each opening.

For each of the two internal flow paths 26 formed side by side in the axial direction of the central tube 3, a partition 31 is provided between the feed hole 35 and the collection hole 36 in the interior of the central tube 3 so as to divide the interior into subspaces in the axial direction.

Next, the flow of the first fluid to be concentrated in the central tube 3 and in the internal flow path 26 is described with reference to FIG. 8. In FIG. 8, arrows schematically indicate the flow of the first fluid. The first fluid fed into the forward osmosis membrane module 100 through the central feed tube 7A flows into the central tube 3 through the feed inlet 33. The first fluid flowing into the central tube 3 through the feed inlet 33 flows into the upstream-side internal flow path 26 through the feed hole 35, the tubular flow path 20C, and then the inlet opening 26A, and flows in the internal flow path 26. The second fluid (a liquid to be diluted) fed through the peripheral feed tube 8A flows outside the membrane leaf 15, and thus the first fluid and the second fluid flow along the surfaces of the forward osmosis membrane 13. Therefore, a portion of the first fluid flowing in the internal flow path 26 moves to the outside of the membrane leaf 15 through the forward osmosis membrane 13 by osmotic phenomenon. The rest of the first fluid not having moved to the outside of the membrane leaf 15 from the upstream-side internal flow path 26 leaves the internal flow path 26 through the outlet opening 26B and returns into the central tube 3 through the tubular flow path 20C and the collection hole 36. A portion of the first fluid having returned into the central tube 3 flows in the downstream-side internal flow path 26 in the same manner. The rest of the first fluid not having moved to the outside of the membrane leaf 15 from the downstream-side internal flow path 26 returns into the central tube 3, and then is discharged to the outside of the forward osmosis membrane element 2 through the discharge port 34.

As shown in FIG. 8, the first fluid having entered the internal flow path 26 through the inlet opening 26A first flows in a direction away from the central tube 3 (i.e., an inflow direction). Then, the flow of the first fluid takes a 180-degree turn in the middle of the internal flow path 26, and thus the first fluid flows in a direction toward the central tube 3 (i.e., an outflow direction). In this manner, the first fluid flows in two or more opposing directions in the internal flow path 26. The flow path member 10 is disposed in the internal flow path 26 in such a manner that the first filaments 11A and the second filaments 11B extend obliquely to the inflow direction or the outflow direction. Since the first fluid flows along the first filaments 11A and the second filaments 11B, the first fluid is easily led to the corners of the U-shaped internal flow path 26. Therefore, the efficiency of using the forward osmosis membrane 13 is increased.

In the above-described embodiment, the first fluid to be concentrated is fed into the central tube 3 and into the membrane leaf 15. However, the second fluid to be diluted may be fed into the central tube 3 and into the membrane leaf 15 so as to cause the first fluid to be concentrated to flow outside the membrane leaf 15. In this case, the flow rate of the fluid discharged from the central discharge tube 7B is higher than the flow rate of the fluid fed to the central feed tube 7A. On the other hand, the flow rate of the fluid discharged from the peripheral discharge tube 8B is lower than the flow rate of the fluid fed to the peripheral feed tube 8A.

The forward osmosis membrane element 2 is not limited to a spiral-wound element. The forward osmosis membrane element 2 may be a flat-type element including a stack of membrane units, each of which is composed of the flow path member 10 and the forward osmosis membranes 13 placed on both sides of the flow path member 10.

### EXAMPLES

The present invention is described in detail by way of Examples. The present invention is not limited to the following Examples.

### Example

(Preparation of flow path member)

90-mesh (i.e., a mesh count of 90) polypropylene plain weave nets each having a thickness of 0.125 mm (125 μm) were disposed on both sides of a 40-mesh (i.e., a mesh count of 40) polypropylene net having a thickness of 0.5 mm (500 μm) and a hydraulic diameter Dh of 0.25 mm and having a structure as shown in FIG. 2A to FIG. 2C. Thus, a flow path member according to Example was obtained.

(Preparation of evaluation membrane)

139 parts by weight of bisphenol A epoxy resin (“EPICOAT 828” manufactured by Japan Epoxy Resin Co., Ltd.), 93.2 parts by weight of bisphenol A epoxy resin (“EPICOAT 1010” manufactured by Japan Epoxy Resin Co., Ltd.), 52 parts by weight of bis(4-aminocyclohexyl)methane, and 500 parts by weight of polyethylene glycol 200 (manufactured by Sanyo Chemical Industries, Ltd.) were mixed to prepare an epoxy resin composition. A cylindrical mold (with an outer diameter of 35 cm and an inner diameter of 10.5 cm) was filled with the epoxy resin composition up to a height of 30 cm, which was then room-temperature cured at 25° C. for 12 hours and further reaction-cured at 130° C. for 18 hours. Thus, a cylindrical resin block was obtained. The resin block rotating about its cylindrical axis was continuously sliced from the surface into a thickness of 145 μm using a cutting machine (manufactured by Toshiba Machine Co., Ltd.). Thus, a long strip of epoxy resin sheet (with a length of 100 m) was obtained. This epoxy resin sheet was immersed in pure water for 12 hours to remove polyethylene glycol, followed by drying in a drying oven at 50° C. for about 4 hours. Thus, a porous epoxy resin membrane (with a thickness of 130 μm, a porosity of 45%, and an average pore diameter of 0.04 μm) was obtained.

3.0 g of m-phenylenediamine, 0.15 g of sodium lauryl sulfate, 6.0 g of benzenesulfonic acid, 3.0 g of triethylamine, and 87.85 g of water were mixed to prepare an aqueous solution (B). The aqueous solution (B) was applied onto the porous epoxy resin membrane having been treated with atmospheric pressure plasma so as to remove an excess aqueous amine solution. Next, an isooctane solution containing 0.2% of trimesic acid chloride was applied onto the porous epoxy resin membrane. Then, an excess isooctane solution was removed and the resulting membrane was held in a drying oven at 100° C. for 2 minutes so as to form a polyamide skin layer (with a thickness of about 200 nm) on the porous epoxy resin membrane. Thus an evaluation membrane was obtained. The thickness of the finally obtained evaluation membrane was 130 μm.

(Evaluation of pressure drop)

For the evaluation membrane and the flow path member of Example mentioned above, the pressure drop was evaluated using a cell for flat membrane evaluation “C10-T” (manufactured by Nitto Denko Corporation). The evaluation membrane and the flow path member mentioned above were placed in a pressure resistant cell with an effective width of 35 mm and an effective length of 130 mm. The pressure on the skin layer side of the evaluation membrane was set to 1.2 MPa. Pure water was fed to the cell from the porous epoxy resin membrane side (from the flow path member side) so as to cause the water to flow at flow rates of 20 mL/min, 50 mL/min, 100 mL/min, and 150 mL/min, respectively. The pressure drop at each of these flow rates was measured with a manometer. The pressure drops at pure water flow rates of 20 mL/min, 50 mL/min, 100 mL/min, and 150 mL/min were 35 kPa/m, 73 kPa/m, 187 kPa/m, and 235 kPa/m, respectively.

(Evaluation of membrane damage)

The evaluation membrane and the flow path member of Example mentioned above were placed upon each other and cut into a circular shape with a diameter of 75 mm to obtain a damage evaluation sample. A dye solution (solution of “Basic Violet 1” manufactured by Tokyo Chemical Industry Co., Ltd.) was cross-flowed on the skin layer side of the evaluation membrane in this damage evaluation sample at a linear velocity of 0.1 to 0.2 cm/sec and passed through the sample under an operating pressure of 1.5 MPa for 30 minutes or more. Then, the evaluation sample was visually observed to determine whether the evaluation membrane had a dyed portion.

### Comparative Example

The pressure drop and membrane damage were evaluated in the same manner as in Example except that a tricot flow path member having a thickness of 0.23 mm, 39 wales per inch, and 44 courses per inch was used as a flow path member. When grooves were arranged parallel to the flow direction of pure water (in a 0-degree direction) in the flow path member of Comparative Example, the pressure drops at pure water flow rates of 20 mL/min, 50 mL/min, 100 mL/min, and 150 mL/min were 100 kPa/m, 156 kPa/m, 481 kPa/m, and 749 kPa/m, respectively. When grooves were arranged in a direction perpendicular to the flow direction of pure water (in a 90-degree direction), the pressure drops at pure water flow rates of 20 mL/min, 50 mL/min, 100 mL/min, and 150 mL/min were 137 kPa/m, 270 kPa/m, 931 kPa/m, and 1677 kPa/m, respectively. As a result of membrane damage evaluation, a dyed portion was found, which revealed that the membrane was damaged.

When pure water flowed at the same flow rate, the pressure drop in the membrane using the flow path member of Example was lower than that in the membrane using the flow path member of Comparative Example. This revealed that the flow path member of Example was superior to the flow path member of Comparative Example in terms of reducing the pressure drop. The result of the membrane damage evaluation showed that the use of the flow path member of Example reduced the damage of the membrane compared with the use of the flow path member of Comparative Example.

1. A flow path member comprising:
a first net comprising first filaments and second filaments that are joined together so that the first filaments extend in a first direction and form one surface of the first net and the second filaments extend in a second direction that intersects the first direction and form the other surface of the first net; and
second nets each having smoother surfaces than the surfaces of the first net, wherein
the second nets are disposed on both sides of the first net.

2. The flow path member according to claim 1, having a hydraulic diameter Dh of 0.2 mm or more, the hydraulic diameter being defined by the following equation:
Dh=4ab/(2a+2b)
where “a” is a height of the first filaments or the second filaments from a reference plane including an interface between the first filaments and the second filaments, and “b” is a distance between the adjacent first filaments or between the adjacent second filaments.

3. The flow path member according to claim 1, wherein the second net is a woven fabric.

4. The flow path member according to claim 1, wherein the second net is a net having a mesh count of 50 or more.

5. The flow path member according to claim 1, wherein the first net has a mesh count equal to or lower than the mesh count of the second net.

6. A forward osmosis membrane element comprising:
the flow path member according to claim 1; and
forward osmosis membranes disposed on both sides of the flow path member.

7. The forward osmosis membrane element according to claim 6, further comprising:
a central tube; and
a membrane leaf comprising the flow path member and the forward osmosis membranes, formed in an envelope shape, and wound around the central tube, wherein
the membrane leaf has an internal flow path formed therein, the internal flow path forming a U-shaped curve from an inlet opening to an outlet opening and communicating with an interior of the central tube through the inlet opening and the outlet opening.
